(19) United States
(12) Patent Application Publication
(10) Pub. No.: US 2026/0099991 A1
(43) Pub. Date: Apr. 9, 2026

(54) CONVERTING NEURAL RADIANCE FIELDS TO 3D GAUSSIANS

(71) Applicant: NVIDIA CORPORATION, Santa Clara, CA (US)

(72) Inventors: Kaiwen JIANG, La Jolla, CA (US); Koki NAGANO, Playa Vista, CA (US); Shalini DE MELLO, San Francisco, CA (US); Michael STENGEL, San Jose, CA (US)

(21) Appl. No.: 19/351,781

(22) Filed: Oct. 7, 2025

Related U.S. Application Data
(60) Provisional application No. 63/704,966, filed on Oct. 8, 2024.

(51) Int. Cl. G06T 15/20; G06T 15/06

(52) U.S. Cl. CPC G06T 15/205; G06T 15/06

(57) ABSTRACT

Converting neural radiance fields to three-dimensional (3D) Gaussians includes receiving multi-view images, projecting camera rays through each of the multi-view images, generating first 3D points by sampling each of the camera rays, generating first five-dimensional (5D) input coordinates from the first 3D points and a corresponding two-dimensional (2D) viewing direction, processing the first 5D input coordinates using a neural network to generate first 3D Gaussians, generating second 3D points by sampling each of the camera rays, generating second 5D input coordinates from the second 3D points and the corresponding 2D viewing direction, processing the second 5D input coordinates using the neural network to generate second 3D Gaussians, and pruning the first 3D Gaussians summed with the second 3D Gaussians.

### CROSS-REFERENCE TO RELATED APPLICATIONS

This application claims priority benefit of the United States Provisional Patent Application titled, “TECHNIQUES FOR CONVERTING NEURAL FIELDS TO 3D GAUSSIANS,” filed on Oct. 8, 2024, and having Ser. No. 63/704,966. The subject matter of this related application is hereby incorporated herein by reference.

### BACKGROUND OF THE INVENTION

### Field of the Invention

Embodiments of the present disclosure relate generally to autonomous vehicle technology, three-dimensional mapping and environmental modeling, and artificial intelligence and, more specifically, to techniques for converting neural radiance fields to 3D Gaussians.

### Description of the Related Art

Three-dimensional (3D) scene reconstruction is the task of generating an accurate 3D representation of a scene from a set of two-dimensional (2D) images of the scene. 3D scene reconstruction has numerous applications in a wide variety of fields, including computer graphics, animation, and autonomous vehicle mapping and navigation.

Current techniques for 3D scene reconstruction are based on neural radiance field (NERF) approaches. NERF is a technique used to reconstruct a 3D scene from a set of 2D images. NERF trains a multi-layer perceptron (MLP) network to map a five-dimensional (5D) input coordinate to a volume density and view dependent emitted radiance. Given a 2D image of a scene, NERF first projects camera rays through the scene to generate a sampled set of 3D points representing 3D spatial locations. The sampled set of 3D points and corresponding 2D viewing directions are input into an MLP network and the output of that network is a set of emitted colors and volume densities. A 2D image can then be rendered from the colors and volume densities using conventional volume rendering techniques, such as by casting a ray and accumulating colors and densities. NeRF trains the MLP by minimizing the rendering loss between the rendered image and the ground truth 2D image. NERF then uses the trained network to render new views of the scene from different viewpoints.

One drawback of NeRF, however, is that for each new rendered view of the scene this technique needs to re-project the camera rays through the scene for every different viewpoint. In addition, one NeRF can represent only one scene. Therefore, for each new 3D scene reconstruction, the NeRF must be retrained. As a result, training a 3D generative model that uses NeRF as an underlying 3D representation, such as efficient geometry aware 3D generative adversarial networks (EG3D) or live 3D portrait (LP3D), can take a significant amount of time and consume large amounts of computing resources. These computational costs can limit the overall effectiveness and usefulness of using NeRF in 3D generative models.

Another drawback of NeRF is that this technique gives a continuous representation implicitly representing the empty or occupied spaces of the 3D scene. As a result, NeRF requires sampling of dense points along each camera ray to determine if the space is occupied. However, dense sampling is computationally expensive and sampling free space and occluded regions along each camera ray may result in poor rendered image quality. In addition, the implicit representation limits the use of NeRFs in traditional 3D content creation applications, such as in game engines and for computer generated images.

As the foregoing illustrates, what is needed in the art are more effective techniques for 3D scene reconstruction.

### SUMMARY

According to some embodiments, a computer-implemented method for converting a neural radiance field to three-dimensional (3D) Gaussians includes receiving a plurality of multi-view images, projecting a plurality of camera rays through each of the plurality of multi-view images, generating a plurality of first 3D points by sampling each of the plurality of camera rays, generating a plurality of first five-dimensional (5D) input coordinates from the plurality of first 3D points and a corresponding two-dimensional (2D) viewing direction, processing the plurality of first 5D input coordinates using a neural network to generate a plurality of first 3D Gaussians, generating a plurality of second 3D points by sampling each of the plurality of camera rays, generating a plurality of second 5D input coordinates from the plurality of second 3D points and the corresponding 2D viewing direction, processing the plurality of second 5D input coordinates using the neural network to generate a plurality of second 3D Gaussians, and pruning the plurality of first 3D Gaussians summed with the plurality of second 3D Gaussians.

Further embodiments provide, among other things, non-transitory computer-readable storage media storing instructions and systems configured to implement the method set forth above.

At least one technical advantage of the disclosed techniques relative to the prior art is that, with the disclosed techniques, a trained 3D reconstruction model using a neural radiance field representation can be converted to a 3D reconstruction model using a 3D Gaussian representation. The disclosed techniques generate accurate reconstruction of 3D scenes from a set of multi-view images without having to re-project the camera rays through the scene for every viewpoint, which significantly reduces the computing resources used to generate the reconstructed 3D scene. In addition, the disclosed techniques eliminate sampling of free space and occluded regions along camera rays, significantly improving the quality of the 3D reconstruction, and significantly improving the inference time without sacrificing the rendered image quality. Further, the disclosed techniques give an explicit representation compatible with traditional computer generated image pipelines. These technical advantages represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a block diagram of a computer-based system configured to implement one or more aspects of the various embodiments;

FIG. 5 is a more detailed description of the 3D scene reconstruction engine of FIG. 4, according to various embodiments;

FIG. 6 is a more detailed illustration of the 3D Gaussian converter of FIG. 4, according to various embodiments;

FIG. 7 is a flow diagram of method steps for generating a reconstructed 3D scene, according to various embodiments;

FIG. 8 is a flow diagram of method steps for converting a neural radiance field representation to 3D Gaussians, according to various embodiments; and

FIG. 9 is a flow diagram of method steps for training 3D Gaussian converter, according to various embodiments.

### DETAILED DESCRIPTION

In the following description, numerous specific details are set forth to provide a more thorough understanding of the present invention. However, it will be apparent to one of skill in the art that the present invention may be practiced without one or more of these specific details.

Embodiments of the present disclosure provide techniques for reconstruction of a 3D scene by converting a neural radiance field representation to 3D Gaussians using a set of multi-view images. First, camera rays are projected through each multi-view image, and each camera ray is uniformly sampled to generate a first set of 3D points. The first set of 3D points with the corresponding 2D viewing directions are input into an MLP. The output of the MLP is a first set of 3D Gaussians, each with parameters including scale, rotation, position, density, and color. Based on the density of each 3D Gaussian in the first set of 3D Gaussian, each camera ray is sampled again, with the samples biased towards the regions expected to contain visible content, to generate a second set of 3D points. The second set of 3D points with the corresponding 2D viewing directions are then input into the MLP. The output of the MLP is a second set of 3D Gaussians, each with parameters including scale, rotation, position, density, and color. Next, the second set of 3D Gaussians is filtered to remove the 3D Gaussians with color values below a threshold. The remaining 3D Gaussians are rendered into a 2D image using a splatting based rasterization technique. Then, the MLP is trained by minimizing the rendering loss between the rendered image and the ground truth image. After training, the MLP outputs optimized 3D Gaussians which are usable to reconstruct a 3D scene that closely matches the originally observed multi-view images.

The techniques for converting neural radiance fields to 3D Gaussians from multi-view data collections have many real world applications. For example, these techniques can be used in systems where 3D scenes are reconstructed using 2D images, such as vehicle navigation systems, and/or the like. These techniques also have applications in virtual and augmented reality, as well as medical imaging.

The above examples are not in any way intended to be limiting. As persons skilled in the art will appreciate, as a general matter, the techniques of converting neural radiance fields to 3D Gaussians that are described herein can be implemented in any application where 3D reconstruction of scenes using multi-view images is required or useful.

### System Overview

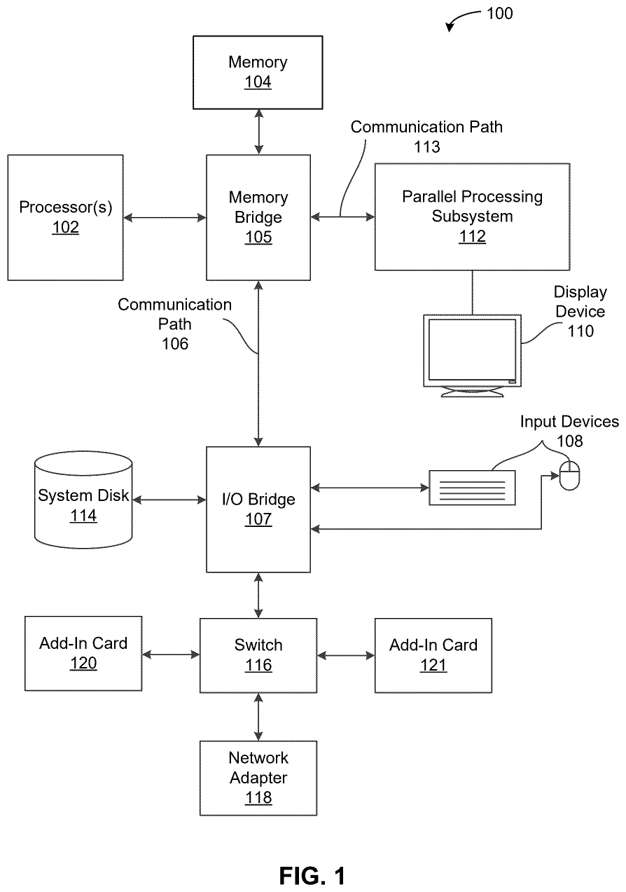

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, one or more processor(s) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to processor(s) 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 118. In one embodiment, switch 116 is configured to provide connections between I/O bridge 107 and other components of computer system 100, such as a network adapter 118 and various add-in cards 120 and 121.

In one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

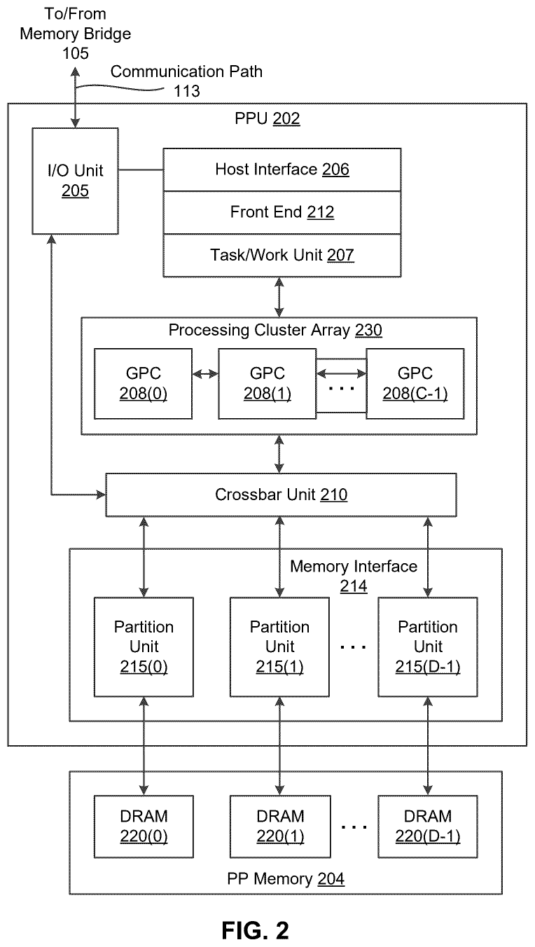

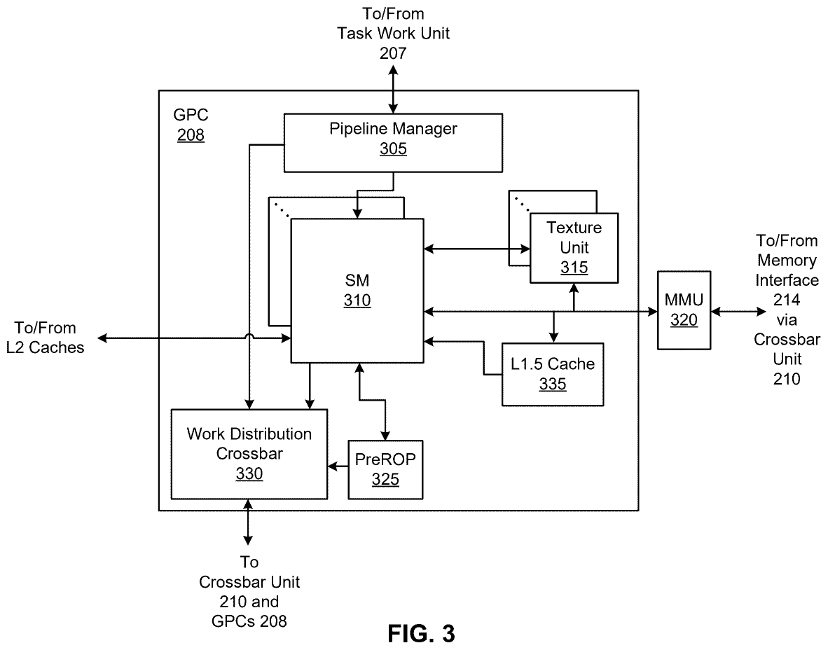

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on chip (SoC).

In one embodiment, processor(s) 102 include the master processor of computer system 100, controlling and coordinating operations of other system components. In one embodiment, processor(s) 102 issue commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in some embodiments, system memory 104 could be connected to processor(s) 102 directly rather than through memory bridge 105, and other devices would communicate with system memory 104 via memory bridge 105 and processor(s) 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by processor(s) 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 118.

In some embodiments, processor(s) 102 include the master processor of computer system 100, controlling and coordinating operations of other system components. In one embodiment, processor(s) 102 issue commands that control the operation of PPU 202. In some embodiments, processor(s) 102 write a stream of commands for PPU 202 to a data structure (not explicitly shown in either FIG. 1 or FIG. 2) that may be located in system memory 104, PP memory 204, or another storage location accessible to both processor(s) 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of processor(s) 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with processor(s) 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including processor(s) 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### 3D Gaussian Generation and Use

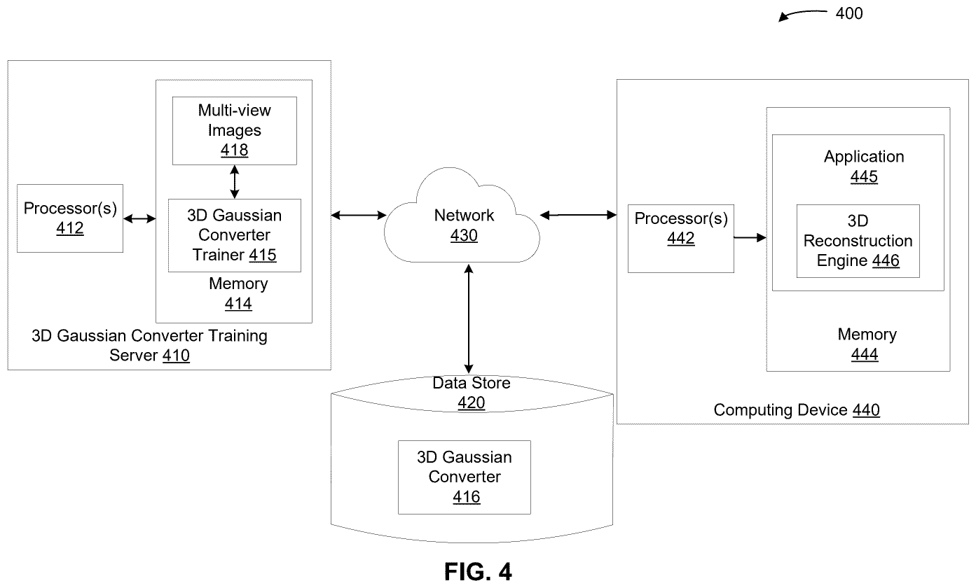

FIG. 4 illustrates a block diagram of a computer-based system 400 configured to implement one or more aspects of the various embodiments. As shown computer-based system 400 includes, without limitation, a 3D Gaussian converter training server 410, a data store 420, a network 430, and a computing device 440. 3D Gaussian converter training server 410 includes, without limitation, processor(s) 412 and a memory 414. Memory 414 includes, without limitation, a 3D Gaussian converter trainer 415 and multi-view images 418. Computing device 440 includes, without limitation, processor(s) 442 and memory 444. Memory 444 includes, without limitation, an application 445. Application 445 includes, without limitation, 3D reconstruction engine 446. Data store 420 stores, without limitation, 3D Gaussians converter 416. Each of the 3D Gaussian converter training server 410 and the computing device 440 can include similar components, features, and/or functionality as the exemplary computer system 100, described above in conjunction with FIGS. 1-3. Each of 3D Gaussian converter training server 410 and computing device 440 can be any technically feasible type of computer system, including, without limitation, a server machine or a server platform.

3D Gaussian converter training server 410 shown herein is for illustrative purposes only, and variations and modifications are possible without departing from the scope of the present disclosure. For example, the number and types of processors 412, the number of GPUs and/or other processing unit types, the number and types of memories 414, and/or the number of applications included in the memory 414 can be modified as desired. Further, the connection topology between the various units within 3D Gaussian converter training server 410 can be modified as desired. In some embodiments, any combination of the processor(s) 412 and the memory 414, and/or GPU(s) can be included in and/or replaced with any type of virtual computing system, distributed computing system, and/or cloud computing environment, such as a public, private, or a hybrid cloud system.

Processor(s) 412 receive user input from input devices, such as a keyboard or a mouse. Processor(s) 412 can be any technically feasible form of processing device configured to process data and execute program code. For example, any of processor(s) 412 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 412, or any combination of these different processors, such as a CPU working in cooperation with one or more GPUs. In various embodiments, the processor(s) 412 can issue commands that control the operation of one or more GPUs (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 414 of 3D Gaussian converter training server 410 stores content, such as software applications and data, for use by processor(s) 412. Memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 414. The storage can include any number and type of external memories that are accessible to processor(s) 412. For example, and without limitation, the storage can include a Secure Digital Card, an external Flash memory, a portable compact disc read-only memory (CD-ROM), an optical storage device, a magnetic storage device, and/or any suitable combination of the foregoing.

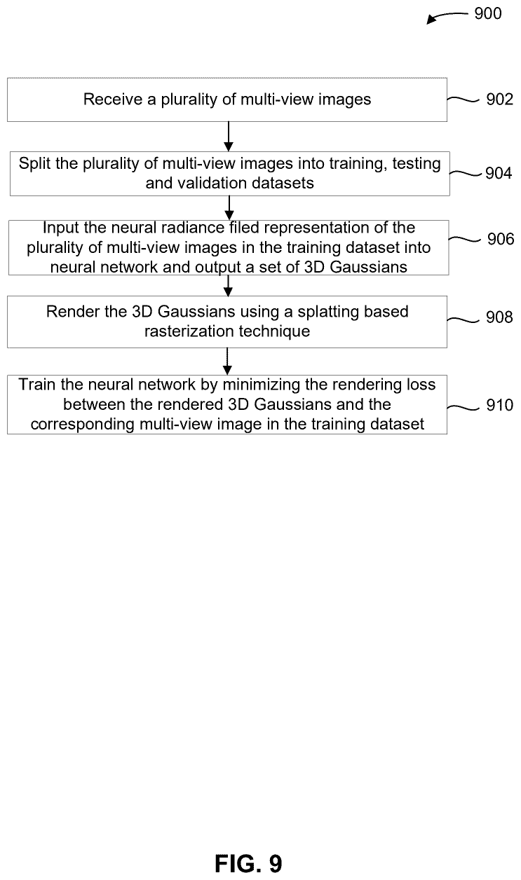

3D Gaussian converter trainer 415 stored within memory 414 is configured to train 3D Gaussians converter 416. 3D Gaussian converter trainer 415 trains 3D Gaussian converter using multi-view images 418. In operation, 3D Gaussian converter trainer 415 prepares multi-view images 418 by splitting multi-view images 418 into training, testing, and validation datasets. During the training process, 3D Gaussian converter trainer 415 uses a neural network to convert the neural radiance field representation of the multi-view images 418 in the training dataset to a set of 3D Gaussians. 3D Gaussian converter trainer 415 then renders the 3D Gaussians onto a 2D image using a splatting based rasterization technique. 3D Gaussian converter trainer 415 then optimizes the parameters of the neural network of 3D Gaussian converter 416 by minimizing the rendering loss between the rendered 3D Gaussians and the corresponding multi-view image 418 in the training dataset. 3D Gaussian converter trainer 415 can use any feasible training technique to train 3D Gaussian converter 416, such as stochastic gradient descent. During training, 3D Gaussian converter trainer 415 minimizes the rendering loss between the rendered image and the corresponding multi-view image 418 in the training dataset. The rendering loss function can include, without limitation, one or more of mean squared error (MSE), L₁ loss, and/or the like. The operations performed by 3D Gaussian converter trainer 415 are described in greater detail in conjunction with FIG. 9.

Multi-view images 418 are images of the same scene from multiple viewpoints. Multi-view images 418 can be obtained by any type of technically feasible camera or video capture device. For example, and without limitation, multi-view images 418 can be obtained by a monocular camera such as a smartphone camera or a camera located in a vehicle. Although not shown in FIG. 4, multi-view images 418 can be loaded by 3D Gaussian converter trainer 415 from data store 420 and/or one or more other data repositories.

Data store 420 provides non-volatile storage for applications and data in 3D Gaussian converter training server 410 and computing device 440. For example, and without limitation, training data, trained (or deployed) machine learning models and/or application data, multi-view images 418 and 3D Gaussian converter 416 can be stored in the data store 420 for use by application 445. In some embodiments, data store 420 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 420 can be a network attached storage (NAS) and/or a storage area-network (SAN). Although shown as coupled to 3D Gaussian converter training server 410 and computing device 440 via network 430, in various embodiments, 3D Gaussian converter training server 410 or computing device 440 can include data store 420.

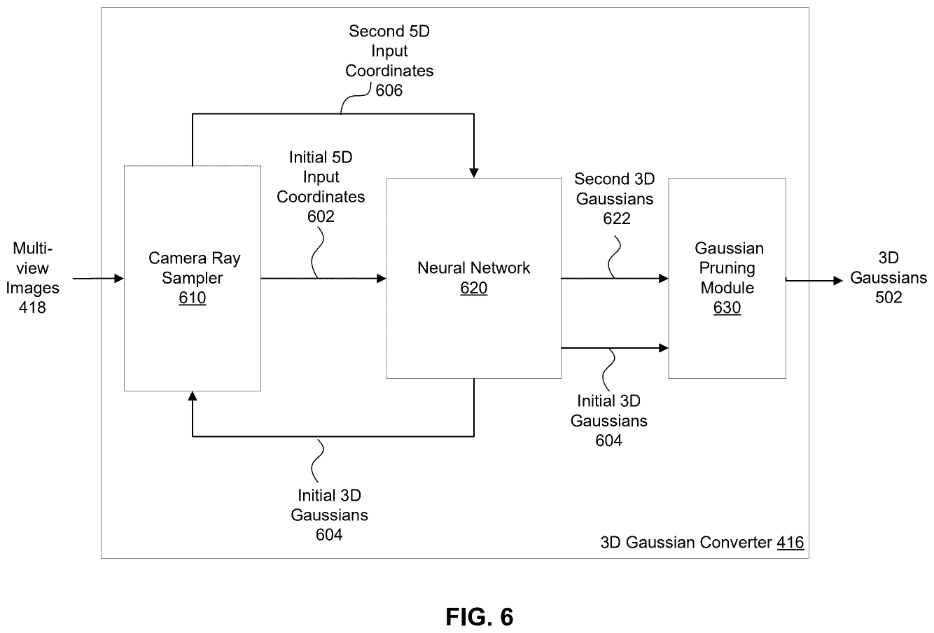

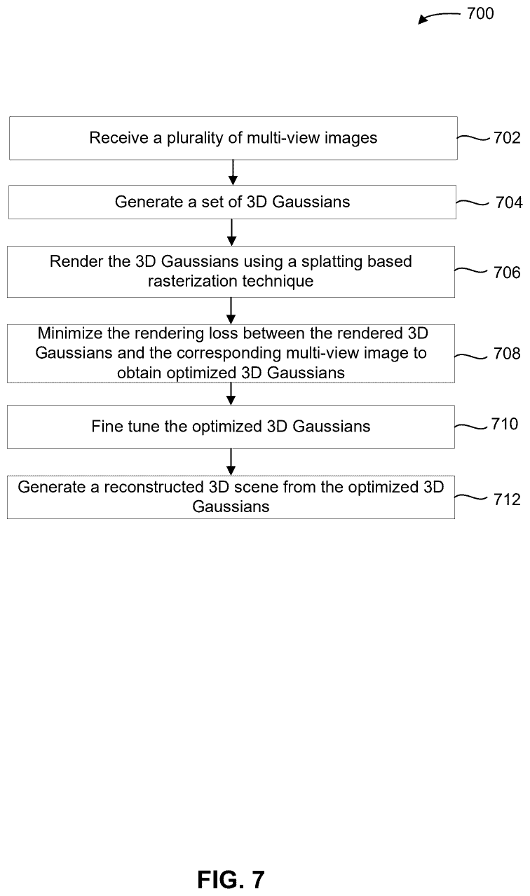

3D Gaussian converter 416 is trained to convert a neural radiance field representation into a 3D Gaussian representation. First, camera rays are projected through each multi-view image 418, and each camera ray is uniformly sampled to generate a first set of 3D points. The first set of 3D points with the corresponding 2D viewing directions are input into an MLP. The output of the MLP is a first set of 3D Gaussians, each with parameters including scale, rotation, position, density, and color. Based on the density of each 3D Gaussian in the first set of 3D Gaussian, each camera ray is sampled again, with the samples biased towards the regions expected to contain visible content, to generate a second set of 3D points. The second set of 3D points with the corresponding 2D viewing directions are then input into the MLP. The output of the MLP is a second set of 3D Gaussians, each with parameters including scale, rotation, position, density, and color. The first set of 3D Gaussians is added the second set of 3D Gaussians and the resulting set of 3D Gaussians is then pruned to remove the 3D Gaussians with color values below a threshold. 3D Gaussian converter 416 can then be used in any suitable application, such as 3D reconstruction engine 446 of application 445 executing on computing device 440. The operations performed by 3D Gaussian converter 416 are described in greater detail below in conjunction with FIGS. 6 and 7.

Network 430 includes any technically feasible type of communications network that allows data to be exchanged between 3D Gaussian converter training server 410, computing device 440, data store 420 and external entities or devices, such as a web server or another networked computing device. For example, network 430 can include a wide area network (WAN), a local area network (LAN), a cellular network, a wireless (WiFi) network, and/or the Internet, among others.

Computing device 440 shown herein is for illustrative purposes only, and variations and modifications are possible without departing from the scope of the present disclosure. For example, the number and types of processor(s) 442, the number and types of memories 444, and/or the number of applications included in the memory 444 can be modified as desired. Further, the connection topology between the various units within computing device 440 can be modified as desired. In some embodiments, any combination of the processor(s) 442 and/or the memory 444 can be included in and/or replaced with any type of virtual computing system, distributed computing system, and/or cloud computing environment, such as a public, private, or a hybrid cloud system. In various embodiments, computing device 440 can be implemented using any of the computing devices of FIGS. 1-3.

Similar to processor(s) 412, processor(s) 442 receive user input from input devices, such as a keyboard or a mouse. Processor(s) 442 can be any technically feasible form of processing device configured to process data and execute program code. For example, any of processor(s) 442 could be a CPU, a GPU, an ASIC, a FPGA, and so forth. In various embodiments any of the operations and/or functions described herein can be performed by processor(s) 442, or any combination of these different processors, such as a CPU working in cooperation with a one or more GPUs. In various embodiments, the one or more GPU(s) perform parallel processing task, such as matrix multiplications and/or the like in LLM model computations. Processor(s) 442 can also receive user input from input devices, such as a keyboard or a mouse and generate output on one or more displays.

Similar to memory 414 of 3D Gaussian converter training server 410, memory 444 of computing device 440 stores content, such as software applications and data, for use by the processor(s) 442. The memory 444 can be any type of memory capable of storing data and software applications, such as a RAM, ROM, EPROM, Flash ROM, or any suitable combination of the foregoing. In some embodiments, a storage (not shown) can supplement or replace the memory 444. The storage can include any number and type of external memories that are accessible to processor(s) 442. For example, and without limitation, the storage can include a Secure Digital Card, an external Flash memory, a portable CD-ROM, an optical storage device, a magnetic storage device, and/or any suitable combination of the foregoing.

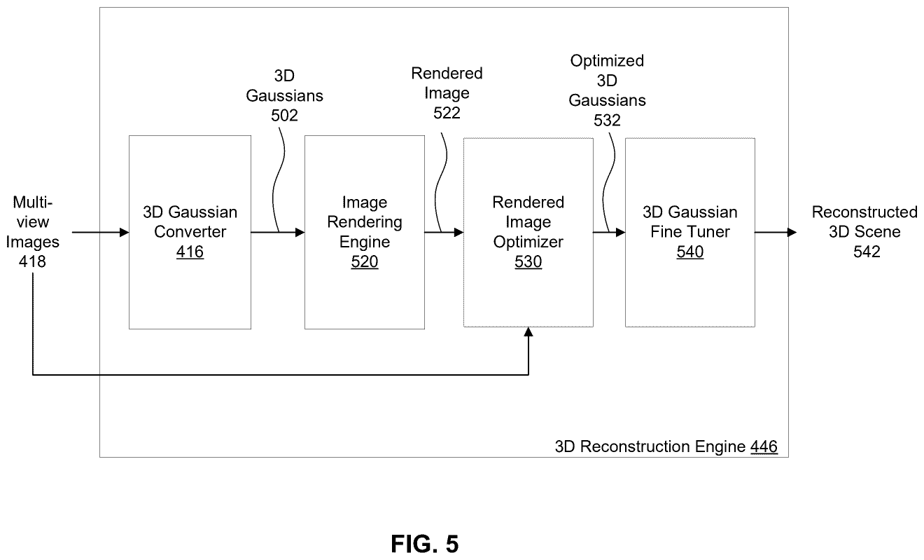

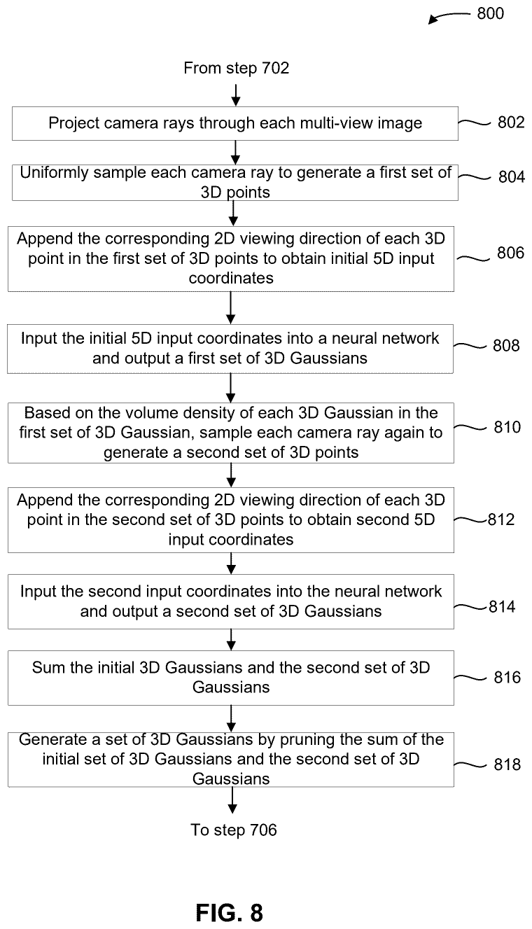

As shown, memory 444 includes application 445. Application 445 includes 3D reconstruction engine 446. 3D reconstruction engine 446 is configured to reconstruct a 3D scene using 3D Gaussians converter 416 and multi-view images 418. In various embodiments, 3D scene reconstruction engine 446 is trained to reconstruct a 3D scene by volume rendering a neural radiance field representation (NeRF). 3D scene reconstruction engine 446 uses 3D Gaussian converter 416 to convert the NeRF representation to a set of 3D Gaussians. The 3D Gaussians are rendered into a 2D image using a splatting based rasterization technique and the parameters of the 3D Gaussians are optimized by minimizing the rendering loss between the rendered image and the multi-view image 418. 3D reconstruction engine 446 then outputs optimized 3D Gaussians which are used to generate a reconstructed 3D scene. The operations performed by 3D reconstruction engine 446 are described in greater detail below in conjunction with FIGS. 5 and 8.

Application 445 can be, without limitation, any type of navigation system, map, or route and direction assistant in an autonomous or manned vehicle and/or a hand-held device. For example, application 445 can access 3D scene reconstruction engine 446 and then use vehicle location and position information and use a reconstructed 3D scene to render an image of the current location. In various embodiments, application 445 shows previews of a planned route, renders a view from specific coordinates, or annotates an image to displays landmarks or other points of interest.

### Reconstructed 3D Scene Generation and Use

FIG. 5 is a more detailed illustration of 3D Gaussian reconstruction engine 446 of FIG. 4, according to various embodiments. As shown, 3D reconstruction engine 446 includes, without limitation, 3D Gaussian converter 416, an image rendering engine 520, a rendered image optimizer 530 and a 3D Gaussian fine tuner 540. 3D Gaussian converter 416 receives multi-view images 418 and generates 3D Gaussians 502. Image rendering engine 520 receives 3D Gaussians 502 and generates rendered image 522. Rendered image optimizer 530 receives rendered image 522 and multi-view images 418 and generates optimized 3D Gaussians 532. 3D Gaussian fine tuner 540 receives optimized 3D Gaussians 532 and generates reconstructed 3D scene 542. 3D reconstruction engine accesses multi-view images 418 and 3D Gaussians converter 416 from data store 420 and generates reconstructed 3D scene 542.

3D Gaussian converter 416 receives multi-view images 418 and generates 3D Gaussians 502. 3D Gaussian converter 416 is trained to convert a neural radiance field representation into a 3D Gaussian representation. The operations of 3D Gaussian converter 416 are described in further detail below in conjunction with FIG. 6.

FIG. 6 is a more detailed illustration of 3D Gaussian converter 416 of FIG. 5, according to various embodiments. As shown, 3D Gaussian converter 416 includes, without limitation, a camera ray sampler 610, a neural network 620, and a Gaussian pruning module 630. Camera ray sampler 610 receives multi-view images 418 and initial 3D Gaussians 604 and generates initial 5D input coordinates 602 and second 5D input coordinates 606. Neural network 620 receives initial 5D input coordinates 602 and second 5D input coordinates 606 and generates initial 3D Gaussians 604 and second 3D Gaussians 622. Gaussian pruning module 630 receives initial 3D Gaussians 604 and second 3D Gaussians 622 and generates 3D Gaussians 502. 3D Gaussian converter 416 receives multi-view images 418 and generates 3D Gaussians 522.

Camera ray sampler 610 receives multi-view images 418. First, camera ray sampler 610 projects camera rays through each multi-view image 418. Each camera ray is given according to equation (1):

$$r ( t ) = o + td \qquad ( 1 )$$

where o is the origin of the camera ray and d is the direction of the camera ray. Camera ray sampler 610 then uniformly samples each camera ray to generate a first set of 3D points, where each 3D point, x=(x,y,z), represents the 3D spatial location. Each camera ray is uniformly sampled according to equation (2):

$${t}_{i} = i \frac{{t}_{f} - {t}_{n}}{N} \qquad ( 2 )$$

where t_{f} and tₙ represent the far and near bounds, and N is the number of equivalent parts the camera ray is divided into. Camera ray sampler 610 then appends the 2D viewing direction d=(θ,φ) of each 3D point x, where (θ,φ) represent spherical coordinates, to generate an initial 5D input coordinate 602 given by (x,d). Camera ray sampler 610 then passes each of initial 5D input coordinates 602 to neural network 620.

Neural network 620 can be any type of technically feasible machine learning model. For example, in various embodiments, neural network 620 can be a multi-layer perceptron with any suitable architecture. More generally, the input dataset to neural network 620 can include any technically feasible data that can be processed by an artificial neural network (ANN) model. Upon receiving initial 5D input coordinates 602, neural network 620 passes initial 5D input coordinates 602 through multiple layers. Each layer of neural network 620 can include a feedforward layer, a non-linear layer, a fully connected layer, a normalization layer, and/or any other type of viable artificial neural network layer. Each layer of neural network 620 has a varying number of internal parameters including, without limitation, numbers of neurons, types of activation function, and/or the like. After passing initial 5D input coordinates 602 though the layers of neural network 620, neural network 620 generates initial 3D Gaussians 604. Neural network 620 then passes initial 3D Gaussians 604 back to camera ray sampler 610.

Each 3D Gaussian in initial 3D Gaussians 604 is defined in terms of the center μ, rotation q, scaling vector s, volume density σ, and color c. The center μ describes the position in 3D space of initial 3D Gaussian 604. q is quaternion vector that describes the rotation of the 3D Gaussian 604, The volume density and the color are dependent on the camera ray r(t). The volume density σ(r(t)) is a positive number representing the probability that the camera ray r(t) terminates at an infinitesimal particle at the point t. The color c(r(t))=(r,g,b) describes the color of the camera ray r(t) at the point t.

Camera ray sampler 610 receives initial 3D Gaussians 604 from neural network 620. Based on the volume density and color of each initial 3D Gaussian, camera ray sampler 610 samples each camera ray again, with the samples biased towards the regions of multi-view image 418 expected to contain visible content. After sampling, camera ray sampler 610 generates a second set of 3D points where each 3D point, x=(x,y,z), represents the 3D spatial location For each 3D point, x=(x,y,z), in the second set of 3D points, camera ray sampler 610 then appends the 2D viewing direction d=(θ,φ), where (θ,φ) represent spherical coordinates, to generate a second 5D input coordinate 542 given by (x,d). Camera ray sampler 610 then passes second 5D input coordinates 606 to neural network 620.

Neural network 620 receives second 5D input coordinates 606 from camera ray sampler 610 and passes second 5D input coordinates 606 through multiple layers. After passing second 5D input coordinates 606 though the layers of neural network 620, neural network 620 generates second 3D Gaussians 622.

Like the 3D Gaussians in initial 3D Gaussians 604, each 3D Gaussian in second 3D Gaussians 622 is defined in terms of the center μ, orientation q, scaling vector s, volume density σ, and color c. The center μ describes the position in 3D space of each second 3D Gaussian 552, q is quaternion vector that describes the rotation of each 3D Gaussian 622, the color c(r(t))=(r,g,b) describes the color of the camera ray r(t) at the point t, and the volume density σ(r(t)) is a positive number representing the probability that the camera ray r(t) terminates at an infinitesimal particle at the point t. Because camera ray sampler 610 sampled each camera ray with the samples biased towards the regions of multi-view image 418 expected to contain visible content, the volume density of each 3D Gaussian in the second 3D Gaussians 622 generally have values closer to 1 than the 3D Gaussians in initial 3D Gaussians 604.

Gaussian pruning module 630 receives initial 3D Gaussians 604 and second 3D Gaussians 622 from neural network 620. Gaussian pruning module 630 first takes the sum of the initial 3D Gaussians 604 and the second 3D Gaussians 622. Gaussian pruning module 630 then removes the 3D Gaussians in the sum of the initial 3D Gaussians 604 and the second 3D Gaussians 622 with color values c below a given threshold. Gaussian pruning module 630 then generates 3D Gaussians 502 from the remaining sum of the initial 3D Gaussians 604 and the second 3D Gaussians 622.

Like the 3D Gaussians in second 3D Gaussians 622, each 3D Gaussian in 3D Gaussians 502 is defined in terms of the center μ, orientation q, scaling vector s, volume density σ, and color c. The center μ describes the position in 3D space of each 3D Gaussian 502, q is quaternion vector that describes the rotation of each 3D Gaussian 502, the volume density σ(r(t)) is a positive number representing the probability that the camera ray r(t) terminates at an infinitesimal particle at the point t, and the color c(r(t))=(r,g,b) describes the color of the camera ray r(t) at the point t. The 3D Gaussians 502 includes the 3D Gaussians in the sum of the initial 3D Gaussians 604 and the second 3D Gaussians 622 with a color value above a given threshold.

Referring back to FIG. 5, image rendering engine 520 receives 3D Gaussians 502. Image rendering engine 520 then uses a splatting-based rasterization technique to generate rendered image 522. More specifically, image rendering engine 520 projects the 3D Gaussians 502 onto a 2D pixel-based image plane. The 3D Gaussians 502 are then sorted and a color of a pixel, C, is computed by blending [symbol] ordered points overlapping the pixel according to equation (3):

$$C = {\sum }_{i ∈ 𝒩} {c}_{i} {α}_{i} {\prod }_{j = 1}^{i - 1} ( 1 - {α}_{j} ) \qquad ( 3 )$$

where cᵢ is the color of each point and αᵢ is the opacity, resulting in rendered image 522. Rendered images 522 are then passed to rendered image optimizer 530.

Rendered image optimizer 530 receives rendered image 522 from image rendering engine 520. Rendered image optimizer trains each rendered image 522 to closely match the corresponding multi-view image 418. Rendered image optimizer 530 can use any feasible training technique to train rendered image 522, such as stochastic gradient descent. During training, rendered image optimizer 530 minimizes the rendering loss between rendered image 522 and the corresponding multi-view image 418. The rendering loss function can include, without limitation, one or more of mean squared error (MSE), L₁ loss, and/or the like.

Rendered image optimizer 530 then updates the parameters [μ,q,s,α,c] of each 3D Gaussian 502 to obtain a set of optimized 3D Gaussians 532. More specifically, rendered image optimizer 530 passes optimized 3D Gaussians 532 to 3D Gaussian fine tuner 540 to improve the quality of the 3D scene reconstruction. In various embodiments, for each optimized 3D Gaussian, 3D Gaussian fine tuner 540 determines whether the optimized 3D Gaussian should be removed or densified. For example, and without limitation, 3D Gaussian fine tuner 540 removes optimized 3D Gaussians 532 with an opacity value below a given threshold. In various embodiments, 3D Gaussian fine tuner 540 also densifies optimized 3D Gaussians 532. For example, and without limitation, 3D Gaussian fine tuner 540 can clone one or more small, optimized 3D Gaussians 532 in an under-constructed region and/or can split one or more large optimized 3D Gaussians 532 into smaller optimized 3D Gaussians 532. After fine-tuning, 3D Gaussian fine tuner 540 outputs reconstructed 3D scene 448 that closely matches multi-view images 418.

### Generating a Reconstructed 3D Scene

FIG. 7 is a flow diagram of method steps for generating a reconstructed 3D scene, according to various embodiments. Although the method steps are described in conjunction with the systems of FIGS. 1-6, persons skilled in the art will understand that any system configured to perform the method steps, in any order, falls within the scope of the various embodiments.

As shown, a method 700 begins at step 702, where 3D reconstruction engine 446 receives multi-view images 418. Multi-view images 418 are images of the same scene from multiple viewpoints. Multi-view images 418 can be obtained by any type of technically feasible camera or video capture device.

At step 704, 3D Gaussian converter 416 generates a set of 3D Gaussians 502. Each 3D Gaussian in the set of 3D Gaussians 502 is defined in terms of the center μ, rotation q, scaling vector s, volume density σ, and color c.

At step 706, image rendering engine 520 renders the 3D Gaussians 502 into a 2D image using a splatting-based rasterization technique. First, image rendering engine 520 projects the 3D Gaussians 502 onto a 2D pixel-based image plane. Image rendering engine 520 then uses equation (3) to compute the color of each pixel of the 2D image plane, resulting in rendered image 522.

At step 708, rendered image optimizer 530 minimizes the rendering loss between the rendered image 522 and the corresponding multi-view image 418 to obtain optimized 3D Gaussians 532. More specifically, rendered image optimizer 530 trains each rendered image 522 to closely match the corresponding multi-view image 418. Rendered image optimizer 530 can use any feasible training technique to train rendered image 522, such as stochastic gradient descent. During training, rendered image optimizer 530 minimizes the rendering loss between rendered image 522 and the corresponding multi-view image 418. The rendering loss function can include, without limitation, one or more of mean squared error (MSE), L₁ loss, and/or the like.

At step 710, 3D Gaussian fine tuner 540 fine tunes the optimized 3D Gaussians 532. More specifically, for each optimized 3D Gaussian 532, 3D Gaussian fine tuner 540 determines if the optimized 3D Gaussian 532 should be removed or densified. For example, and without limitation, 3D Gaussian fine tuner 540 removes optimized 3D Gaussians 532 with an opacity value below a given threshold. In various embodiments, 3D Gaussian fine tuner 540 also densifies optimized 3D Gaussians 532. For example, and without limitation, 3D Gaussian fine tuner 540 can clone one or more small, optimized 3D Gaussians 532 in an under-constructed region and/or can split one or more large optimized 3D Gaussians 532 into smaller optimized 3D Gaussians 532.

At step 712, 3D Gaussian fine tuner 540 generates reconstructed 3D scene 542 from the optimized 3D Gaussians 532. 3D Gaussian fine tuner 540 generates reconstructed 3D scene 542 from the optimized 3D Gaussians 532 that closely match multi-view images 418.

FIG. 8 is a flow diagram of method steps for converting a neural radiance field representation to 3D Gaussians, according to various embodiments. Although the method steps are described in conjunction with the systems of FIG. 1-6, persons skilled in the art will understand that any system configured to perform the method steps, in any order, falls within the scope of the various embodiments.

As shown, a method 800 begins at step 802, where camera ray sampler 610 projects camera rays through each multi-view image 418. Each camera ray is given according to equation (1).

At step 804, camera ray sampler 610 uniformly samples each camera ray to generate a first set of 3D points. Each 3D point, x=(x,y,z), represents the 3D spatial location. Each camera ray is uniformly sampled according to equation (2).

At step 806, camera ray sampler 610 appends the corresponding 2D viewing direction of each 3D point in the first set of 3D points to obtain initial 5D input coordinates 602. More specifically, camera ray sampler 610 appends the 2D viewing direction d=(θ,φ) of each 3D point x, where (θ,φ) represent spherical coordinates, to generate the initial 5D input coordinate 602 given by (x,d).

At step 808, the initial 5D input coordinates 602 are input into a neural network 620 and neural network 620 outputs initial 3D Gaussians 604. Upon receiving initial 5D input coordinates 602, neural network 620 passes initial 5D input coordinates 602 through multiple layers. After passing initial 5D input coordinates 602 through the layers of neural network 620, neural network 620 generates initial 3D Gaussians 604. Each 3D Gaussian in initial 3D Gaussians 604 is defined in terms of the center μ, rotation q, scaling vector s, volume density σ, and color c.

At step 810, based on the volume density of each 3D Gaussian in initial 3D Gaussians 604, camera ray sampler 610 samples each camera ray again to generate a second set of 3D points. More specifically, camera ray sampler 610 samples each camera ray again, with the samples biased towards the regions of multi-view image 418 expected to contain visible content.

At step 812, camera ray sampler 610 appends the corresponding 2D viewing direction of each 3D point in the second set of 3D points to obtain a second 5D input coordinates 606. More specifically, camera ray sampler 610 appends the 2D viewing direction d=(θ,φ) of each 3D point x, where (θ,φ) represent spherical coordinates, to generate the second 5D input coordinate 606 given by (x,d).

At step 814, the second 5D input coordinates 606 are input into neural network 620 and neural network 620 outputs second 3D Gaussians 622. Upon receiving the second 5D input coordinates 606, neural network 620 passes the second 5D input coordinates 606 through multiple layers. After passing the second 5D input coordinates 606 through the layers of neural network 620, neural network 620 generates second 3D Gaussians 622. Each 3D Gaussian in second 3D Gaussians 622 is defined in terms of the center μ, rotation q, scaling vector s, volume density σ, and color c. The volume density values of each 3D Gaussian in the second 3D Gaussians 622 typically have values closer to 1 than the 3D Gaussians in initial 3D Gaussians 604.

At step 816, Gaussian pruning module 630, sums the initial 3D Gaussians 604 and the second 3D Gaussians 622. More specifically, Gaussian pruning module 630 generates a set of 3D Gaussians that contains the 3D Gaussians of initial 3D Gaussians 604 and second 3D Gaussians 622.

At step 818, Gaussian pruning module 630 generates a set of 3D Gaussians 502 by pruning the sum of the initial 3D Gaussians 604 and the second 3D Gaussians 622. More specifically, Gaussian pruning module 630 removes the 3D Gaussians in the sum of the initial 3D Gaussians 604 and the second 3D Gaussians 622 with color values c below a given threshold.

### Training 3D Gaussian Converter

FIG. 9 is a flow diagram of method steps for training 3D Gaussian converter 416, according to various embodiments. Although the method steps are described in conjunction with the systems of FIGS. 1-6, persons skilled in the art will understand that any system configured to perform the method steps, in any order, falls within the scope of the various embodiments.

As shown, a method 900 begins at step 902, where 3D Gaussian converter trainer 415 receives multi-view images 418. Multi-view images 418 are images of the same scene from multiple viewpoints. Multi-view images 418 can be obtained by any type of technically feasible camera or video capture device.

At step 904, 3D Gaussian converter trainer 415 splits multi-view images 418 into training, testing, and validation datasets.

At step 906, 3D Gaussian converter trainer 415 inputs the neural radiance field representation of the multi-view images 418 in the training dataset into a neural network and output a set of 3D Gaussians. A neural radiance field representation of an image represents the image as a 5D coordinate including the 3D spatial location and 2D viewing direction. Each 3D Gaussian in the set of 3D Gaussians is defined in terms of the center μ, rotation q, scaling vector s, volume density σ, and color c.

At step 908, 3D Gaussian converter trainer 415 renders the 3D Gaussians using a splatting based rasterization technique. The 3D Gaussians are projected onto a 2D pixel-based image plane, then the color of each pixel of the 2D image plane is computed according to equation (3), resulting in a rendered image.

At step 910, 3D Gaussian converter trainer 415 trains the neural network by minimizing the rendering loss between the rendered 3D Gaussians and the corresponding multi-view image in the training dataset. 3D Gaussian converter trainer 415 can use any feasible training technique to train the neural network, such as stochastic gradient descent. The rendering loss function can include, without limitation, one or more of mean squared error (MSE), L₁ loss, and/or the like.

In sum, a 3D scene is reconstructed by converting a neural radiance field representation to 3D Gaussians using a set of 2D images of the same scene from multiple viewpoints and. First, camera rays are projected through each multi-view image, and each camera ray is uniformly sampled to generate a first set of 3D points. The first set of 3D points with the corresponding 2D viewing directions are input into an MLP. The output of the MLP is a first set of 3D Gaussians, each with parameters including scale, rotation, position, volume density, and color. Based on the volume density of each 3D Gaussian in the first set of 3D Gaussian, each camera ray is sampled again, with the samples biased towards the regions expected to contain visible content, to generate a second set of 3D points. The second set of 3D points with the corresponding 2D viewing directions are then input into the MLP. The output of the MLP is a second set of 3D Gaussians, each with parameters including scale, rotation, position, volume density, and color. Next, the second set of 3D Gaussians is filtered to remove the 3D Gaussians with color values below a threshold. The remaining 3D Gaussians are rendered into a 2D image using a splatting based rasterization technique. Then, the parameters of the remaining 3D Gaussians are optimized by minimizing the rendering loss between the rendered image and the originally observed image. The optimized 3D Gaussians are usable to reconstruct a 3D scene that closely matches the originally observed multi-view images.

At least one technical advantage of the disclosed techniques relative to the prior art is that, with the disclosed techniques, a trained 3D reconstruction model using a neural radiance field representation can be converted to a 3D reconstruction model using a 3D Gaussian representation. The disclosed techniques generate accurate reconstruction of 3D scenes from a set of multi-view images without having to re-project the camera rays through the scene for every viewpoint, which significantly reduces the computing resources used to generate the reconstructed 3D scene. In addition, the disclosed techniques eliminate sampling of free space and occluded regions along camera rays, significantly improving the quality of the 3D reconstruction, and significantly improving the inference time without sacrificing the rendered image quality. Further, the disclosed techniques give an explicit representation compatible with traditional computer generated image pipelines. These technical advantages represent one or more technological improvements over prior art approaches.

Aspects of the subject matter described herein are set out in the following numbered clauses.

1. In some embodiments, a computer-implemented method for converting a neural radiance field to a plurality of three-dimensional (3D) Gaussians comprises receiving a plurality of multi-view images, projecting a plurality of camera rays through each of the plurality of multi-view images, generating a plurality of first 3D points by sampling each of the plurality of camera rays, generating a plurality of first five-dimensional (5D) input coordinates from the plurality of first 3D points and a corresponding two-dimensional (2D) viewing direction, processing the plurality of first 5D input coordinates using a neural network to generate a plurality of first 3D Gaussians, generating a plurality of second 3D points by sampling each of the plurality of camera rays, generating a plurality of second 5D input coordinates from the plurality of second 3D points and the corresponding 2D viewing direction, processing the plurality of second 5D input coordinates using the neural network to generate a plurality of second 3D Gaussians, and pruning a sum of the plurality of first 3D Gaussians and the plurality of second 3D Gaussians to generate a plurality of pruned 3D Gaussians.

2. The computer-implemented method of clause 1, wherein generating the plurality of first 3D points comprises uniformly sampling each of the plurality of camera rays.

3. The computer-implemented method of clauses 1 or 2, wherein generating the plurality of first 5D input coordinates comprises appending the corresponding 2D viewing direction of each 3D point of the plurality of first 3D points to the plurality of first 3D points.

4. The computer-implemented method of any of clauses 1-3, wherein generating the plurality of second 3D points comprises sampling each camera ray with samples biased towards regions of the plurality of multi-view images expected to contain visible content.

5. The computer-implemented method of any of clauses 1-4, wherein pruning the sum of the plurality of first 3D Gaussians and the plurality of second 3D Gaussians comprises pruning the sum of the plurality of first 3D Gaussians and the plurality of second 3D Gaussians to remove each of the plurality of the sum of the plurality of first 3D Gaussians and the plurality of second 3D Gaussians with color values below a given threshold.

6. The computer-implemented method of any of clauses 1-5, wherein the neural network comprises a multi-layer perceptron.

7. The computer-implemented method of any of clauses 1-6, further comprising generating a reconstructed 3D scene using the plurality of pruned 3D Gaussians.

8. The computer-implemented method of any of clauses 1-7, wherein generating the reconstructed 3D scene using the plurality of pruned 3D Gaussians comprises projecting each of the plurality of pruned 3D Gaussians to generate a plurality of rendered 2D images, generating optimized 3D Gaussians from the plurality of rendered 2D images, and generating the reconstructed 3D scene from the optimized 3D Gaussians.

9. The computer-implemented method of any of clauses 1-8, wherein projecting each of the plurality of pruned 3D Gaussians to generate the plurality of rendered 2D images comprises projecting each of the plurality of pruned 3D Gaussians onto a pixel-based image plane using a splatting-based rasterization technique.

10. The computer-implemented method of any of clauses 1-9, wherein generating the optimized 3D Gaussians comprises minimizing rendering loss between the plurality of rendered 2D images and corresponding images of the plurality of multi-view images.

11. The computer-implemented method of any of clauses 1-10, wherein generating the optimized 3D Gaussians further comprises fine tuning the optimized 3D Gaussians by removing optimized 3D Gaussians having an opacity value below a threshold.

12. The computer-implemented method of any of clauses 1-11, wherein generating the optimized 3D Gaussians further comprises fine tuning the optimized 3D Gaussians by densifying the optimized 3D Gaussians.

13. In some embodiments, one or more non-transitory computer-readable media store instructions that, when executed by at least one processor, cause the at least one processor to perform the steps of receiving a plurality of multi-view images, projecting a plurality of camera rays through each of the plurality of multi-view images, generating a plurality of first 3D points by sampling each of the plurality of camera rays, generating a plurality of first five-dimensional (5D) input coordinates from the plurality of first 3D points and a corresponding two-dimensional (2D) viewing direction, processing the plurality of first 5D input coordinates using a neural network to generate a plurality of first 3D Gaussians, generating a plurality of second 3D points by sampling each of the plurality of camera rays, generating a plurality of second 5D input coordinates from the plurality of second 3D points and the corresponding 2D viewing direction, processing the plurality of second 5D input coordinates using the neural network to generate a plurality of second 3D Gaussians, and pruning a sum of the plurality of first 3D Gaussians and the plurality of second 3D Gaussians to generate a plurality of pruned 3D Gaussians.

14. The one or more non-transitory computer-readable media of clause 13, wherein generating the plurality of first 3D points comprises uniformly sampling each of the plurality of camera rays.

15. The one or more non-transitory computer-readable media of clauses 13 or 14, wherein generating the plurality of second 3D points comprises sampling each camera ray with samples biased towards regions of the plurality of multi-view images expected to contain visible content.

16. The one or more non-transitory computer-readable media of any of clauses 13-15, wherein the steps further comprise generating a reconstructed 3D scene using the plurality of pruned 3D Gaussians.

17. The one or more non-transitory computer-readable media of any of clauses 13-16, wherein the neural network comprises a multi-layer perceptron.

18. The one or more non-transitory computer-readable media of any of clauses 13-17, wherein the steps further comprise generating a reconstructed 3D scene using the plurality of pruned 3D Gaussians by projecting each of the plurality of pruned 3D Gaussians to generate a plurality of rendered 2D images, generating optimized 3D Gaussians from the plurality of rendered 2D images and generating the reconstructed 3D scene from the optimized 3D Gaussians.

19. The one or more non-transitory computer-readable media of any of clauses 13-18, wherein generating the optimized 3D Gaussians comprises minimizing rendering loss between the plurality of rendered 2D images and corresponding images of the plurality of multi-view images.

20. In some embodiments, a system comprises one or more memories storing instructions, and one or more processors that are coupled to the one or more memories and, when executing the instructions, are configured to perform steps comprising receiving a plurality of multi-view images, projecting a plurality of camera rays through each of the plurality of multi-view images, generating a plurality of first 3D points by sampling each of the plurality of camera rays, generating a plurality of first five-dimensional (5D) input coordinates from the plurality of first 3D points and a corresponding two-dimensional (2D) viewing direction, processing the plurality of first 5D input coordinates using a neural network to generate a plurality of first 3D Gaussians, generating a plurality of second 3D points by sampling each of the plurality of camera rays, generating a plurality of second 5D input coordinates from the plurality of second 3D points and the corresponding 2D viewing direction, processing the plurality of second 5D input coordinates using the neural network to generate a plurality of second 3D Gaussians, and pruning a sum of the plurality of first 3D Gaussians and the plurality of second 3D Gaussians, to generate a plurality of pruned 3D Gaussians.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for converting a neural radiance field to a plurality of three-dimensional (3D) Gaussians, the method comprising:
receiving a plurality of multi-view images;
projecting a plurality of camera rays through each of the plurality of multi-view images;
generating a plurality of first 3D points by sampling each of the plurality of camera rays;
generating a plurality of first five-dimensional (5D) input coordinates from the plurality of first 3D points and a corresponding two-dimensional (2D) viewing direction;
processing the plurality of first 5D input coordinates using a neural network to generate a plurality of first 3D Gaussians;
generating a plurality of second 3D points by sampling each of the plurality of camera rays;
generating a plurality of second 5D input coordinates from the plurality of second 3D points and the corresponding 2D viewing direction;
processing the plurality of second 5D input coordinates using the neural network to generate a plurality of second 3D Gaussians; and
pruning a sum of the plurality of first 3D Gaussians and the plurality of second 3D Gaussians to generate a plurality of pruned 3D Gaussians.

2. The computer-implemented method of claim 1, wherein generating the plurality of first 3D points comprises uniformly sampling each of the plurality of camera rays.

3. The computer-implemented method of claim 1, wherein generating the plurality of first 5D input coordinates comprises appending the corresponding 2D viewing direction of each 3D point of the plurality of first 3D points to the plurality of first 3D points.

4. The computer-implemented method of claim 1, wherein generating the plurality of second 3D points comprises sampling each camera ray with samples biased towards regions of the plurality of multi-view images expected to contain visible content.

5. The computer-implemented method of claim 1, wherein pruning the sum of the plurality of first 3D Gaussians and the plurality of second 3D Gaussians comprises pruning the sum of the plurality of first 3D Gaussians and the plurality of second 3D Gaussians to remove each of the plurality of the sum of the plurality of first 3D Gaussians and the plurality of second 3D Gaussians with color values below a given threshold.

6. The computer-implemented method of claim 1, wherein the neural network comprises a multi-layer perceptron.

7. The computer-implemented method of claim 1, further comprising generating a reconstructed 3D scene using the plurality of pruned 3D Gaussians.

8. The computer-implemented method of claim 7, wherein generating the reconstructed 3D scene using the plurality of pruned 3D Gaussians comprises:
projecting each of the plurality of pruned 3D Gaussians to generate a plurality of rendered 2D images;
generating optimized 3D Gaussians from the plurality of rendered 2D images; and
generating the reconstructed 3D scene from the optimized 3D Gaussians.

9. The computer-implemented method of claim 8, wherein projecting each of the plurality of pruned 3D Gaussians to generate the plurality of rendered 2D images comprises projecting each of the plurality of pruned 3D Gaussians onto a pixel-based image plane using a splatting-based rasterization technique.

10. The computer-implemented method of claim 8, wherein generating the optimized 3D Gaussians comprises minimizing rendering loss between the plurality of rendered 2D images and corresponding images of the plurality of multi-view images.

11. The computer-implemented method of claim 8, wherein generating the optimized 3D Gaussians further comprises fine tuning the optimized 3D Gaussians by removing optimized 3D Gaussians having an opacity value below a threshold.

12. The computer-implemented method of claim 8, wherein generating the optimized 3D Gaussians further comprises fine tuning the optimized 3D Gaussians by densifying the optimized 3D Gaussians.

13. One or more non-transitory computer-readable media storing instructions that, when executed by at least one processor, cause the at least one processor to perform the steps of:
receiving a plurality of multi-view images;
projecting a plurality of camera rays through each of the plurality of multi-view images;
generating a plurality of first 3D points by sampling each of the plurality of camera rays;
generating a plurality of first five-dimensional (5D) input coordinates from the plurality of first 3D points and a corresponding two-dimensional (2D) viewing direction;
processing the plurality of first 5D input coordinates using a neural network to generate a plurality of first 3D Gaussians;
generating a plurality of second 3D points by sampling each of the plurality of camera rays;
generating a plurality of second 5D input coordinates from the plurality of second 3D points and the corresponding 2D viewing direction;
processing the plurality of second 5D input coordinates using the neural network to generate a plurality of second 3D Gaussians; and
pruning a sum of the plurality of first 3D Gaussians and the plurality of second 3D Gaussians to generate a plurality of pruned 3D Gaussians.

14. The one or more non-transitory computer-readable media of claim 13, wherein generating the plurality of first 3D points comprises uniformly sampling each of the plurality of camera rays.

15. The one or more non-transitory computer-readable media of claim 13, wherein generating the plurality of second 3D points comprises sampling each camera ray with samples biased towards regions of the plurality of multi-view images expected to contain visible content.

16. The one or more non-transitory computer-readable media of claim 13, wherein the steps further comprise generating a reconstructed 3D scene using the plurality of pruned 3D Gaussians.

17. The one or more non-transitory computer-readable media of claim 13, wherein the neural network comprises a multi-layer perceptron.

18. The one or more non-transitory computer-readable media of claim 13, wherein the steps further comprise generating a reconstructed 3D scene using the plurality of pruned 3D Gaussians by:
projecting each of the plurality of pruned 3D Gaussians to generate a plurality of rendered 2D images;
generating optimized 3D Gaussians from the plurality of rendered 2D images and generating the reconstructed 3D scene from the optimized 3D Gaussians.

19. The one or more non-transitory computer-readable media of claim 18, wherein generating the optimized 3D Gaussians comprises minimizing rendering loss between the plurality of rendered 2D images and corresponding images of the plurality of multi-view images.

20. A system, comprising:
one or more memories storing instructions; and
one or more processors that are coupled to the one or more memories and, when executing the instructions, are configured to perform steps comprising:
receiving a plurality of multi-view images;
projecting a plurality of camera rays through each of the plurality of multi-view images;
generating a plurality of first 3D points by sampling each of the plurality of camera rays;
generating a plurality of first five-dimensional (5D) input coordinates from the plurality of first 3D points and a corresponding two-dimensional (2D) viewing direction;
processing the plurality of first 5D input coordinates using a neural network to generate a plurality of first 3D Gaussians;
generating a plurality of second 3D points by sampling each of the plurality of camera rays;
generating a plurality of second 5D input coordinates from the plurality of second 3D points and the corresponding 2D viewing direction;
processing the plurality of second 5D input coordinates using the neural network to generate a plurality of second 3D Gaussians; and
pruning a sum of the plurality of first 3D Gaussians and the plurality of second 3D Gaussians to generate a plurality of pruned 3D Gaussians.
